(19) United States
(12) Patent Application Publication
(10) Pub. No.: US 2022/0182243 A1
(43) Pub. Date: Jun. 9, 2022

(54) Method and Apparatus for Distributed Ledger

(71) Applicant: Telefonaktiebolaget LM Ericsson (PUBL), Stockholm (SE)

(72) Inventors: Zhancang Wang, BEIJING (CN); Bo ZHONG, BEIJING (CN)

(21) Appl. No.: 17/605,439

(22) PCT Filed: Apr. 25, 2019
(86) PCT No.: PCT/CN2019/084238

§ 371 Date: Oct. 21, 2021

(51) Int. Cl. H04L 9/32; H04L 45/64; H04L 45/7453

(52) U.S. Cl. CPC H04L 9/3247; H04L 2209/38; H04L 45/7453; H04L 45/64

(57) ABSTRACT

Embodiments of the present disclosure provide methods and apparatuses for distributed ledger. A method at a first node of a first communication network may comprise receiving a message including payload and transmission chain information on a transmission chain along which the message is transmitted, wherein the transmission chain information includes a signature and identification information of a source node of the transmission chain, identification information of a destination node of the transmission chain, identification information of the first node, and respective signature and identification information of one or more forward nodes that have forwarded the message along the transmission chain; and updating the transmission chain information by adding identification information of a next hop node in the transmission chain information, generating a signature of the first node, and adding the signature of the first node in the transmission chain information; and sending the message including the payload and the updated transmission chain information or the updated transmission chain information to the next hop node.

### TECHNICAL FIELD

The non-limiting and exemplary embodiments of the present disclosure generally relate to the technical field of communications, and specifically to methods and apparatuses for distributed ledger.

### BACKGROUND

This section introduces aspects that may facilitate a better understanding of the disclosure. Accordingly, the statements of this section are to be read in this light and are not to be understood as admissions about what is in the prior art or what is not in the prior art.

A distributed ledger is a consensus of replicated, shared, and synchronized digital data spread across several nodes (devices) on a peer-to-peer network. There is no central administrator or centralized data storage. When a ledger update happens, each node constructs a new transaction, and then the nodes vote by using consensus algorithm on which copy is correct. Once a consensus has been determined, all the other nodes update themselves with the new, correct copy of the ledger. One form of distributed ledger is a blockchain system, which can be either public or private. With blockchain technology, a transaction can take place in a decentralized fashion. Blockchain can implement simple yet effective and powerful mechanisms for creating a wide and varied range of computer-implemented systems. Such systems can include various devices such as IoT (Internet of Things) devices. IoT devices are embedded with electronic circuits, software, sensors, and networking capabilities etc. to enable them to communicate with other devices and systems, often via wireless means, and to perform desired tasks. In some cases, the IoT devices may be very small and contain only limited processing, networking and storage capacity.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

IoT is an extension of the Internet. The terminal side of the IoT extends to information exchange and communication between arbitrary objects, which is a so-called object-object relationship.

There are several shortcomings in the field of IoT. For example, IoT vendors are currently isolated, forming a series of data islands, and the information flow is extremely unsmooth. Cross-vendor access and clearing is a problem. Under the current IoT ecosystem, all devices are authenticated through a central server. The connections between devices are handled through the central server, and the efficiency cannot meet the real-time needs of the IoT. The way in which IoT devices are centrally managed makes its operating costs extremely high and even impossible to make profit. The IoT devices are connected to the central server for data transmission and control, but these high operating costs have made IoT vendors not profitable as they scale. In addition, the privacy issues of IoT devices are becoming more prominent, including identity, address tracking, user data analysis, information leakage, and hacking. For example, due to the centralization design of traditional IoT architecture, user behavior data is stored on central, merchant-controlled servers. As a result, users' data is vulnerable to data leakage and users' privacy and security are exposed to serious threats. In the current IoT, multiple devices are simply connected, and each device does not generate more value because of its own data. However, the value of IoT devices may come from automatic coordination between heterogeneous devices and the main body. Through individual collaboration, ultimately, large data values may be generated. The current IoT devices and entities cannot quantify value and do not have immediate value circulation. The infrastructure and maintenance costs of centralized servers, data servers, and network equipment are very high. When the number of IoT devices increases to for example tens of billions, it will generate huge amounts of communication information, making IoT solutions very expensive. The centralized network has extremely high security requirements for the central server, and the security breach of the central server will affect the nodes in the entire network. The existing centralized network can collect user privacy at will, and after the user realizes the value of his/her data, the user will gradually dislike and even protest. The existing IoT cannot obtain user trust because it involves more information from users, including for example health information and vehicle travel information. A problem of localizing information dissemination has not been solved. Under the current centralized structure, it is difficult for the IoT to achieve true autonomous cooperation and effective transactions, as the relevant parties to such cooperation and transactions often belong to different interest groups with complex and uncertain trust relationships. Therefore, the collaboration and transaction of the current IoT devices can only be performed under the same trust domain, the collaboration and trading devices are provided or verified by the same IoT service provider.

Blockchain has provided decentralized ideas and technologies that may be suited for autonomous exchange between machines in the IoT industry. However, the blockchain technology has some limitations for IoT platform developments. For example, data block producing time may not be fast enough and serial processing flow may limit the throughput of the IoT system, etc.

To overcome or mitigate at least one above mentioned problems or other problems or provide a useful solution, the embodiments of the present disclosure propose a solution that allows data and resources to be freely circulated and ensure user privacy in an untrusted decentralized machine federation.

In a first aspect of the disclosure, there is provided a method at a first node of a first communication network. The method comprises receiving a message including payload and transmission chain information on a transmission chain along which the message is transmitted, wherein the transmission chain information includes a signature and identification information of a source node of the transmission chain, identification information of a destination node of the transmission chain, identification information of the first node, and respective signature and identification information of one or more forward nodes that have forwarded the message along the transmission chain; updating the transmission chain information by adding identification information of a next hop node in the transmission chain information, generating a signature of the first node, and adding the signature of the first node in the transmission chain information; and sending the message including the payload and the updated transmission chain information or the updated transmission chain information to the next hop node.

In an embodiment, the method may further comprise verifying the transmission chain information.

In an embodiment, the transmission chain information may further include a hash of the payload.

In an embodiment, the identification information of a node may include a public key and/or address of the node.

In an embodiment, the signature of the source node may be calculated by signing the message and the signature of the forward node or the destination node may be calculated by signing a previous hop node's signature and a next hop node's identification information.

In an embodiment, the first communication network may be an overlay network.

In an embodiment, a peer discovery, routing algorithm and tunnel establishment of the overlay network of the first communication network use a distributed hash table (DHT) routing algorithm.

In an embodiment, the first node may be a forward node, and sending the message including the payload and the updated transmission chain information or the updated transmission chain information to a next hop node may comprise sending the message including the payload and the updated transmission chain information to the next hop node.

In an embodiment, the first node may be the destination node, and sending the message including the payload and the updated transmission chain information or the updated transmission chain information to a next hop node may comprise sending the updated transmission chain information to the next hop node, wherein the next hop node is a node of a second communication network and the nodes of second communication network verify the updated transmission chain information and store the verified transmission chain information in a distributed ledger of the second communication network.

In an embodiment, the second communication network may be an overlay network.

In an embodiment, a peer discovery, routing algorithm and tunnel establishment of the overlay network of the second communication network may use a distributed hash table (DHT) routing algorithm.

In an embodiment, the first communication network may comprise Internet of things (IoT) devices and the second communication network may comprise servers.

In an embodiment, the IoT devices may comprise IoT routers and IoT terminals.

In a second aspect of the disclosure, there is provided a method at a source node of a first communication network. The method comprises obtaining a payload; and sending a message including the payload and transmission chain information on a transmission chain along which the message is transmitted to a next hop node, wherein the transmission chain information includes a signature and identification information of the source node of the transmission chain, identification information of a destination node of the transmission chain, identification information of the next hop node.

In a third aspect of the disclosure, there is provided a method at a second node of a second communication network. The method comprises receiving transmission chain information on a transmission chain along which a message is transmitted from a node of the first communication network, wherein the transmission chain information includes a signature and identification information of a source node of the transmission chain, a signature and identification information of a destination node of the transmission chain, identification information of the second node, and respective signature and identification information of one or more forward nodes that have forwarded the message along the transmission chain; verifying the transmission chain information; when the transmission chain information passes the verification, adding a signature of the second node in the transmission chain information; storing the transmission chain information with the signature of the second node; and sending the transmission chain information with the signature of the second node to a next hop node.

In an embodiment, the method according to the third aspect of the disclosure may further comprise receiving updated transmission chain information including one or more other nodes' signatures and identification information from a node of the second communication network; verifying the updated transmission chain information; when the updated transmission chain information passes the verification, updating the stored transmission chain information based on the updated transmission chain information; sending the updated stored transmission chain information or an updated part of the updated stored transmission chain information to one or more nodes of the second communication network; and when the updated stored transmission chain information comprises a predefined number of nodes' signatures of the second communication network, storing the updated stored transmission chain information in a distributed ledger of the second communication network.

In an embodiment, the transmission chain information may further include a time out mechanism for transmission, and the transmission chain information will be propagated based on the time out mechanism for transmission.

In a fourth aspect of the disclosure, there is provided a method at a third node of a second communication network. The method comprises receiving transmission chain information on a transmission chain along which a message is transmitted from a node of the second communication network, wherein the transmission chain information includes a signature and identification information of a source node of the transmission chain, a signature and identification information of a destination node of the transmission chain, respective signature and identification information of one or more forward nodes that have forwarded the message along the transmission chain, and respective signature and identification information of one or more nodes of the second communication network that have verified the transmission chain information; verifying the transmission chain information; when the transmission chain information passes the verification, adding a signature of the third node in the transmission chain information; storing the transmission chain information with the signature and identification information of the third node; and sending the transmission chain information with the signature and identification information of the third node to a next hop node.

In an embodiment, the method according to the fourth aspect of the disclosure may further comprise receiving updated transmission chain information including one or more other nodes' signatures and identification information from a node of the second communication network; verifying the updated transmission chain information; when the updated transmission chain information passes the verification, updating the stored transmission chain information based on the updated transmission chain information; sending the updated stored transmission chain information or an updated part of the updated stored transmission chain information to one or more nodes of the second communication network; and when the updated stored transmission chain information comprises a predefined number of nodes' signatures of the second communication network, storing the updated stored transmission chain information in a distributed ledger of the second communication network.

In a fifth aspect of the disclosure, there is provided an apparatus at a first node of a first communication network. The apparatus comprises a processor; and a memory coupled to the processor, said memory containing instructions executable by said processor, whereby said apparatus is operative to receive a message including payload and transmission chain information on a transmission chain along which the message is transmitted, wherein the transmission chain information includes a signature and identification information of a source node of the transmission chain, identification information of a destination node of the transmission chain, identification information of the first node, and respective signature and identification information of one or more forward nodes that have forwarded the message along the transmission chain; and update the transmission chain information by adding identification information of a next hop node in the transmission chain information, generating a signature of the first node, and adding the signature of the first node in the transmission chain information; and send the message including the payload and the updated transmission chain information or the updated transmission chain information to the next hop node.

In a sixth aspect of the disclosure, there is provided an apparatus at a source node of a first communication network. The apparatus comprises a processor; and a memory coupled to the processor, said memory containing instructions executable by said processor, whereby said apparatus is operative to obtain a payload; and send a message including the payload and transmission chain information on a transmission chain along which the message is transmitted to a next hop node, wherein the transmission chain information includes a signature and identification information of the source node of the transmission chain, identification information of a destination node of the transmission chain, identification information of the next hop node.

In a seventh aspect of the disclosure, there is provided an apparatus at a second node of a second communication network. The apparatus comprises a processor; and a memory coupled to the processor, said memory containing instructions executable by said processor, whereby said apparatus is operative to receive transmission chain information on a transmission chain along which a message is transmitted from a node of the first communication network, wherein the transmission chain information includes a signature and identification information of a source node of the transmission chain, a signature and identification information of a destination node of the transmission chain, identification information of the second node, and respective signature and identification information of one or more forward nodes that have forwarded the message along the transmission chain; verify the transmission chain information; when the transmission chain information passes the verification, add a signature of the second node in the transmission chain information; store the transmission chain information with the signature of the first node; and send the transmission chain information with the signature of the second node to one or more nodes of the second communication network.

In an eighth aspect of the disclosure, there is provided an apparatus at a third node of a second communication network. The apparatus comprises a processor; and a memory coupled to the processor, said memory containing instructions executable by said processor, whereby said apparatus is operative to receive transmission chain information on a transmission chain along which a message is transmitted from a node of the second communication network, wherein the transmission chain information includes a signature and identification information of a source node of the transmission chain, a signature and identification information of a destination node of the transmission chain, respective signature and identification information of one or more forward nodes that have forwarded the message along the transmission chain, and respective signature and identification information of one or more nodes of the second communication network that have verified the transmission chain information; verify the transmission chain information; when the transmission chain information passes the verification, adding a signature of the third node of the second communication network in the transmission chain information; store the transmission chain information with the signature of the third node; and send the transmission chain information with the signature of the third node to one or more nodes of the second communication network.

In a ninth aspect of the disclosure, there is provided a computer program product, comprising instructions which, when executed on at least one processor, cause the at least one processor to carry out the method according to the first aspect of the disclosure.

In a tenth aspect of the disclosure, there is provided a computer program product, comprising instructions which, when executed on at least one processor, cause the at least one processor to carry out the method according to the second aspect of the disclosure.

In an eleventh aspect of the disclosure, there is provided a computer program product, comprising instructions which, when executed on at least one processor, cause the at least one processor to carry out the method according to the third aspect of the disclosure.

In a twelfth aspect of the disclosure, there is provided a computer program product, comprising instructions which, when executed on at least one processor, cause the at least one processor to carry out the method according to the fourth aspect of the disclosure.

In a thirteenth aspect of the disclosure, there is provided a computer-readable storage medium storing instructions which when executed by at least one processor, cause the at least one processor to carry out the method according to the first aspect of the disclosure.

In a fourteenth aspect of the disclosure, there is provided a computer-readable storage medium storing instructions which when executed by at least one processor, cause the at least one processor to carry out the method according to the second aspect of the disclosure.

In a fifteenth aspect of the disclosure, there is provided a computer-readable storage medium storing instructions which when executed by at least one processor, cause the at least one processor to carry out the method according to the third aspect of the disclosure.

In a sixteenth aspect of the disclosure, there is provided a computer-readable storage medium storing instructions which when executed by at least one processor, cause the at least one processor to carry out the method according to the fourth aspect of the disclosure.

In a seventeenth aspect of the disclosure, there is provided a system. The system comprises a first communication network including a plurality of apparatus according to the fifth and sixth aspects of the disclosure and a second communication network including a plurality of apparatus according to the seventh and eighth aspects of the disclosure.

Many advantages may be achieved by applying the proposed solution according to embodiments of the present disclosure. For example, there is significant autonomy compared to the central server by using the proposed distributed ledger technology. It can leverage resources at the edge of the network, such as storage/computing capabilities and information resources. It no longer needs a specific central management mechanism, and all nodes in the system have a peer relationship. This aspect brings the advantages of self-organization, fault tolerance and scalability to the system.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically shows a system according to an embodiment of the disclosure;

FIG. 2 shows a flowchart of a method according to an embodiment of the present disclosure;

FIG. 3 shows a flowchart of a method according to another embodiment of the present disclosure;

FIG. 4 shows a flowchart of a method according to another embodiment of the present disclosure;

FIG. 5 shows a flowchart of a method according to another embodiment of the present disclosure;

FIG. 6 shows a flowchart of a method according to another embodiment of the present disclosure;

FIG. 7 shows a flowchart of a method according to another embodiment of the present disclosure;

FIG. 8 shows a flowchart of a method according to another embodiment of the present disclosure;

FIG. 9 schematically shows a data structure of a message;

FIG. 10 schematically shows a construction process of a transmission chain;

FIG. 11 illustrates a simplified block diagram of an apparatus according to an embodiment of the present disclosure;

FIG. 12 illustrates a simplified block diagram of an apparatus according to another embodiment of the present disclosure;

FIG. 13 illustrates a simplified block diagram of an apparatus according to another embodiment of the present disclosure; and

FIG. 14 illustrates a simplified block diagram of an apparatus according to another embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

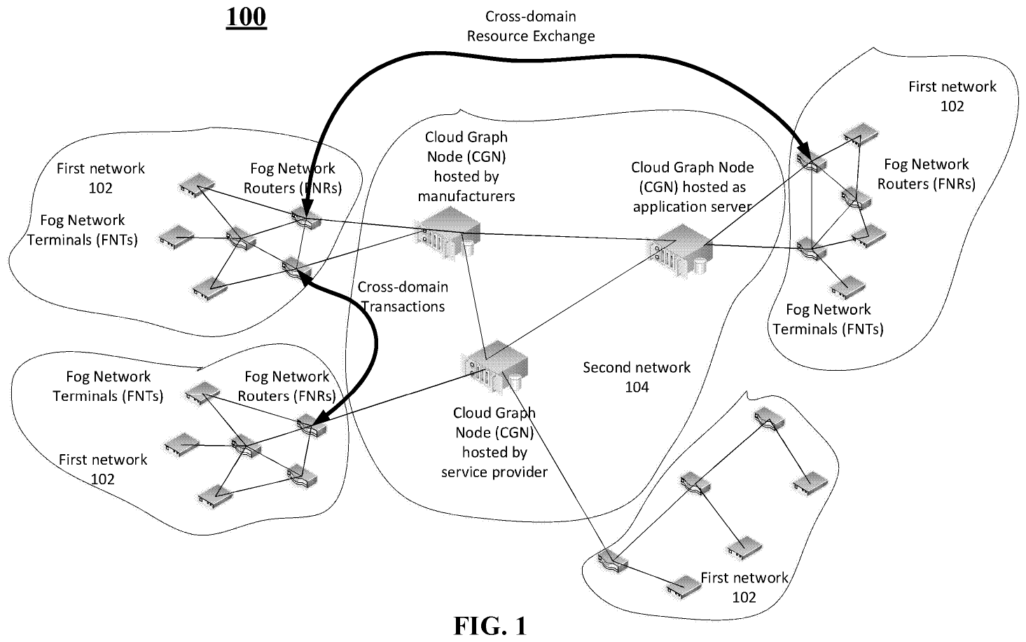

It is noted that some embodiments of the present disclosure are mainly described in relation to the system as shown in FIG. 1 being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does not limit the present disclosure naturally in any way. Rather, any other network configurations and system deployments may equally be utilized as long as exemplary embodiments described herein are applicable.

For illustrative purposes, several embodiments of the present disclosure will be described in the context of IoT application. Those skilled in the art will appreciate, however, that the concept and principle of the several embodiments of the present disclosure may be more generally applicable to any other suitable applications.

FIG. 1 schematically shows a system according to an embodiment of the disclosure. The terms “network” and “system” are often used interchangeably. The system 100 comprises one or more first networks 102 and a second network 104. The number of the first networks 102 as shown in FIG. 1 is only for the purpose of illustration, there may be any other suitable number of the first networks 102 in other embodiments. The system 100 can enable various devices/equipments to complete data compute, data transmission and data storage, and the transmission information such as transmission chain information is recorded by a distributed ledger, which is faster and secure than blockchain. Individual device/equipment may be configured to play a specific role within the system. For example, the devices/equipments of the system 100 may be categorized into two types of nodes such as cloud graph nodes (CGNs) or cloud network nodes in the second network 104 and fog network nodes in the first networks 102. The CGNs can handle a distributed ledger and the fog network node can handle data compute/transmission/storage. CGNs are coordinators who can establish and organize the complete network. There may be multiple CGNs in the second network 104 which may use a consensus mechanism to make decision of transactions. Fog network devices/equipments may be terminal devices which are leaf nodes of the network, and their responsibility may be to provide valuable data. The data could be any suitable data in various application scenarios. For example, in a massive IoT application scenario, the data could be a power usage reading, a string relaying device status, or a reading from a temperature sensor, etc. The fog network devices/equipments may be divided into two types of nodes such as fog network terminals (FNTs) and fog network routers (FNRs). FNTs are pure terminals such as IoT sensors or actuators, while FNRs are the routers with FNTs' function. FNRs can act like end devices like FNTs and report data. In addition, FNRs can act as network repeaters/relayers and extend the reach of the physical network. Please note that the terms “CGN” or “fog network nodes”, “fog network terminal”, “fog network router” or “fog network” etc. as used in this document are used only for ease of description and differentiation among nodes, devices or networks etc. With the development of the technology, other terms with the similar/same meanings may also be used.

In an embodiment, the roles and functions of CGNs, FNTs and FNRs are shown in Table 1.

TABLE 1

| Name | Role | Function |
|---|---|---|
| CGN | Coordinator | Consensus, broadcasting, |
| | | finalizing transactions, |
| | | constructing transmission |
| | | chain, transmission chain |
| | | verifier. |
| FNR | Router and Terminal | Router, sensor or actuator |
| FNT | Terminal | Sensor or actuator |

Multiple CGNs may form the second network 104 which may be dedicated to be used for system (such as IoT platform) consensus and distributed ledger participation. The function of CGNs may be similar as “hashgraph”, but a novel broadcast mechanism and a novel transmission chain instead of gossip and virtual voting are employed in the second network 104.

The system 100 may be a hierarchy structure which separates the responsibility and permission for functions. CGNs may be used for a high performance distributed ledger, while fog networks (FN) and their sub networks are an interface to terminal devices such as IoT devices and terminals. For example, FNRs and FNTs may perform data processing, data transmission and storage, etc. FNRs and FNTs do not participate in consensus in the distributed ledger. However, FNRs and FNTs may provide elements of transactions to CGNs for example in a form of a transmission chain. FNRs play a role of router and terminal and can relay data to other FNRs/FNTs as well as perform FNT's function such as sensing and/or actuating function. FNTs are the terminal devices such as IoT devices which can perform FNT's functions such as sensing or actuating function.

The system 100 may be an overlay network such as distributed hash table (DHT) overlay network. As a first example, all nodes in the system 100 may form a single overlay network and different network domains may occupy different overlay address spaces. For example, each network domain may be allocated with a different prefix of address space and a node identifier of each node and/or an identifier of resource in the each network domain may include a corresponding prefix. As a second example, different network domains such as different first network and the second network may form respective overlay networks and the communication between different network domains may be relayed by the CGNs of the second network.

The overlay network can use software to create layers of network abstraction that can be used to run a separate, discrete virtualized network layer on top of the physical network, which can provide new applications or security benefits. The devices/equipments in the overlay network may be designated by identification tags or numbers, somewhat like the phone system. A device can be located simply by knowing its identification tag or number in the overlay network. These tags may be used to create virtual connections or logical connections.

The overlay network can perform network resource location. The overlay network can use hash functions to speed up query speed and enhance security. The DHT overlay network is easy to manage without taking up too much network bandwidth.

The overlay network is an application-independent technology, because the overlay network is separately added between the application layer and the lower physical network layer. And the overlay network is responsible for querying operation and inserting operation between the upper layer data (such as application layer data) and the lower layer communication node, regardless of the specific application. The keywords obtained by using the hash function do not reflect the meaning of the data. The generation of specific keywords may depend on the developer of the application layer.

An operation of the overlay network is lookup (key). Since each node in the DHT overlay network is responsible for storing a certain range of keywords, an identifier of a node for storing a keyword is returned by a lookup (key) operation, which allows the node to perform store/put and read/get operations according to the keyword. Through the lookup (key) operation of the DHT overlay network, the data of the application layer can be approximately evenly distributed in each node of the whole network or different network domains.

In an embodiment, the overlay network may use DHT as the application layer interface. DHT is not only simple, but also has many advantages compared with the traditional application layer interface, as shown in the following Table 2. Traditional application layer Interface such as User Datagram Protocol/Internet Protocol (UDP/IP) is a communication-centric interface. It can specify the IP address of the node to find and send data. Since the current Internet relies too much on Domain Name System (DNS) and gateways, as long as one of the services has a problem such as failure, no other services are available. The DHT overlay network is a data-centric interface. As long as the key corresponding to the data is given, the resource search can be performed, and it does not care which node the data is stored on and which application the specific data comes from.

TABLE 2

| DHT overlay network application layer | UDP/IP application layer |
|---|---|
| interface | interface |
| Insert(key, data) | Send(IP address, data) |
| Lookup(key) → data | Receive (IP address) → data |

The DHT overlay network can well adapt to the IoT-scale work flow. DHT is a good shared lower layer facility. Since DHT overlay network makes the name of the resource to be encoded into a location or routing link, a unified content-based named layer is formed, which increases the flexibility of finding an object. Since DHT overlay network is a balanced architecture, multiple options can be provided to consider which nodes (and replicas) and which paths to use to store objects (copies) to ensure application layer security. The DHT overlay network is self-organizing and autonomous, so there is no need for extra user operations, which reduces the cost of execution, maintenance, and management. DHT overlay network can make an entity do not know what data it wants to keep, so all entities are able to voluntarily provide computation and storage resources, network bandwidth, and are able to accept any type of data.

The overlay network can map the physical connection relationship of various devices to a virtual spatial topology to form a semi-distributed structure (or Hybrid Structure). The semi-distributed structure draws on the advantages of a centralized structure and a fully distributed unstructured topology. Nodes with higher performance (processing, storage, bandwidth, etc.) are selected as CGNs. CGNs can forward the query request to the appropriate node, such as FNR or FNT. The semi-distributed structure may be a hierarchical structure. For example, a high-speed forwarding layer with a consensus function is formed by CGNs. If the FNR/FNT of different subnets wants to communicate, high-speed relay forwarding can be realized through the CGN network.

The semi-distributed architecture can allow the system 100 to be more scalable because it does not require a single central index server to store data information. It can automatically turn a high performance server into a CGN. The semi-distributed overlay network structure has the advantages of better performance, scalability, and easier management. Because the system 100 uses Hashgraph-like technology to achieve efficient and fast accounting mechanisms, if GGN is completely open, the entire network will be dependent on CGN nodes, vulnerable to attack, and Byzantine fault tolerance will be affected. Therefore, FNT and FNR may be fully open, but CGNs may require a certain permission mechanism to reduce the impact of attack and Byzantine fault tolerance limitations.

Different from the traditional blockchain technology and Hashgraph technology, the ledger records in system 100 are not the transaction or the event itself, but a transmission chain constructed according to the direction of time and data transmission stream. The transmission chain is a data structure which records information such as signature in a time sequence of a sender sending data, one or more relayers (if any) that have forwarded the data, and a receiver receiving the data. Each transmission chain represents a session or a resource exchange process including several necessary transactions in an application.

The CGNs do not use a chain data structure like a blockchain. In order to speed up the transaction and resource exchange, CGNs adopt a graph-like data structure (DAG) similar to a hashgraph. This structure can improve the transaction speed by confirming the concurrent transaction. Unlike the hashgraph technique, CGNs can collect, construct (or extend), and verify the transmission chains in a specific time slot to learn about transactions and events occurring in the network. Once a transmission chain is constructed and verified, the CGNs can complete the verification of the transaction and event without having to communicate for a vote through Byzantine Fault Tolerance to learn the transaction that needs to be confirmed. When a predefined number of the CGNs such as ⅔ of the CGNs complete the construction and verification of the transmission chain, the relevant transactions can be confirmed immediately.

As used herein, cloud graph means a directed acyclic graph (DAG) data structure based network including CGNs. Fog network means a P2P network including edge computing device/equipment. The system 100 combines cloud graph and one or more fog networks to achieve the best performance and efficiency. The cloud graph including servers for example provided by equipment manufacturers and IoT ecosystem enterprises may be the core of the system 100. The cloud graph can be thought of as a decentralized version of the cloud servers. The cloud graph has many CGNs, which may be selected by a community according to a voting mechanism by nodes holding the token, and finally selecting for example 2*N+1 CGNs and N candidate CGNs, wherein N is an integer. A function of the cloud graph is to use a transmission chain verification consensus algorithm for the transaction operation and coordinate the work of the nodes on the fog networks. For example, the cloud graph may correspond to cloud computing and the fog network may correspond to fog computing.

The functions and responsibilities of cloud graph and fog network are different. The separation of permission and responsibilities is conducive to the large-scale deployment of applications such as the IoT application. The applicant recognizes that it is difficult to achieve large-scale deployment by directly integrating all devices/equipments such as IoT devices/equipments into a single blockchain network whose response is rather slow. Another reason is that different applications such as IoT applications require different functions. Putting all nodes in one network will dramatically increase the scale and power, which will eventually make many devices such as IoT devices unbearable. Therefore, each sub network may be allowed to interact with a specific type of devices/equipments by means of separation of permission and responsibilities, and can also interact with other sub networks via a relay by cloud graph. The entire architecture may be a combination of cloud computing and fog computing. The heterogeneous devices may form a cloud graph and one or more edge computing networks, i.e., fog networks. A small edge computing network can connect to the cloud computing network. This separation of powers and responsibilities can create a balanced and scalable system that maximizes efficiency and privacy. Unlike traditional cloud computing and fog computing, DAG technology is used to create the cloud graph and fog networks.

The cloud graph is a powerful DAG ledger that may be far from terminal device such as IoT devices but has powerful computing, storage and networking capabilities. The system 100 may have a cloud graph, i.e., the second network 104 and a plurality of fog networks, i.e., the first networks 102. Moreover, the fog networks can be hierarchical, and sub-fog network can be used to directly link with the terminal devices such as IoT devices. Different fog networks may have different uses, with different architectures and optimization priorities. For example, a fog network may focus on payment scenarios; a fog network running on devices with weak storage capabilities can use a special architecture to reduce storage; a fog network running in a trusted network may not care too much about transaction privacy. The system 100 may be full of heterogeneous nodes, with different strengths, storage, and computation power. In generally, weak capability nodes can do it, and strong capability nodes can be done without a doubt. Therefore, the design and optimization may be based on the weak capability nodes, and the computation power, storage and bandwidth of the weak capability nodes may be given priority.

The distributed ledger technology can support the system 100 with fault tolerance by using Byzantine agreement methods, enhancement with data integrity and reliability during data transmission. The decentralized nature of distributed ledger technology makes a good compensation for existing cloud computing solutions for various applications such as IoT applications. It well matches the decentralized nature of various applications such as IoT applications and enhance existing edge computing devices for data transmission, data verification, attack prevention and guarantee that the value of data can be safely exchanged.

The nodes of the second network 104 may comprise various devices which may have superior performance on compute, storage and networking. The nodes of the second network may comprise for example, cloud computers, servers, virtual machines, personal computers, etc. The nodes of the second network may run with any kind of operating system including, but not limited to, Windows, Linux, UNIX and their variants.

The nodes of the first network 102 may comprise various devices which may not have full capability of computation, storage and networking, less capable than the nodes of the second network. The nodes of the first network may comprise, for example, a portable digital assistant (PDAs), a user equipment, a mobile computer, a desktop computer, a smart television, a gaming apparatus, a laptop computer, a media player, a camera, a video recorder, a mobile phone, a global positioning system (GPS) apparatus, a smart phone, a tablet, a server, a thin client, a virtual server, a set-top box, a computing device, a distributed system, a smart glass, a vehicle navigation system and/or any other types of electronic systems. The nodes of first network 102 may be capable on at least one capability of computation, storage and networking. The node of the first network 102 may run with any kind of operating system including, but not limited to, Windows, Linux, UNIX, Android, iOS and their variants. The nodes of the first network 102 may be referred to as fog computing nodes, without any additional limitation by the term itself.

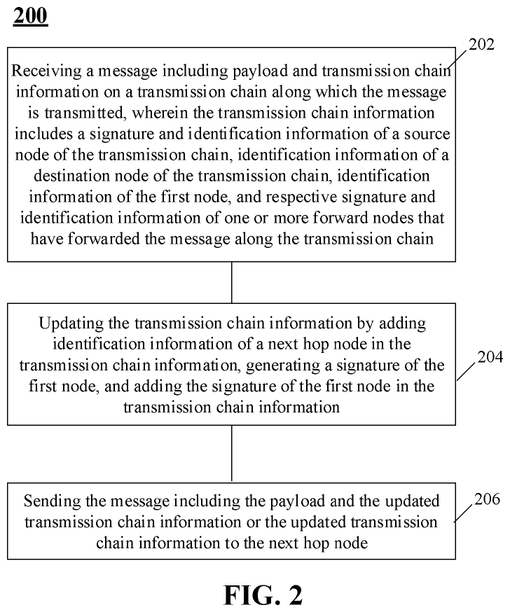

FIG. 2 shows a flowchart of a method according to an embodiment of the present disclosure, which may be performed by an apparatus at a first node of a first communication network or communicatively coupled to a first node of a first communication network. As such, the apparatus may provide means for accomplishing various parts of the method 200 as well as means for accomplishing other processes in conjunction with other components. The first communication network may be the first network 102 or the second network 104 as shown in FIG. 1 or any other suitable communication network.

At block 202, the first node receives a message including payload and transmission chain information on a transmission chain along which the message is transmitted. The message may be received from a source node of the transmission chain or from a forward node on the transmission chain. The source node may be located in the first communication network or another first communication network. The forward node may be located in the first communication network or the second communication network such as the second network 104 as shown in FIG. 1 or another first communication network. The transmission may be a single network domain transmission or cross network domain transmission. As a first example, when the transmission is the cross network domain transmission, the forward node may be the node of the second communication network. In this case the cross network domain transmission is realized by means of the relay of the node of the second communication network. As a second example, when the transmission is the cross network domain transmission, the forward node may be a relay node of another first communication network which can directly communicate with the first communication network. As a third example, when the transmission is the cross network domain transmission, the forward node may be a relay node of the first communication network.

The first node may be a forward node or a destination node. For example, when the source node and the destination node can directly communicate with each other, then there may be not any forward node. For example, when the first communication network is a One-Hop DHT overly network, any two nodes in the One-Hop DHT overly network can directly communicate with each other. When the first node is a forward node, it may be located in the same or different network domain as/from the source node. For example, when the source node is located in the first network 102 as shown in FIG. 1, the first node may be located in the same first network 102 or another first network 102 or the second network 104 as shown in FIG. 1.

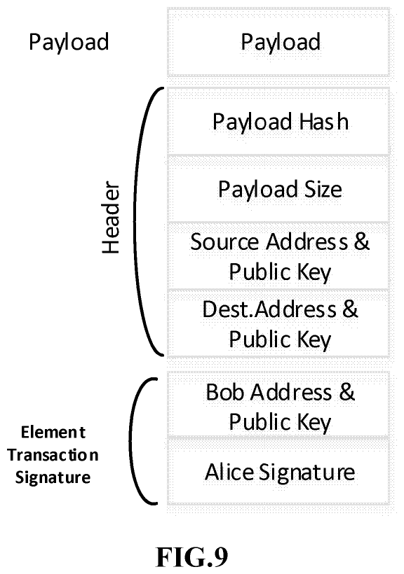

The message can be any suitable message for example depending on the specific type of application. The payload can include any suitable data such as music data, video data, file data, transaction data, various IoT data, etc. FIG. 9 schematically shows a data structure of the message. As shown in FIG. 9, the message may include payload, header including payload hash, payload size, source address & public key and destination address & public key, and element transaction signature.

The transmission chain information may include a signature and identification information of the source node of the transmission chain, identification information of a destination node of the transmission chain, identification information of the first node, and respective signature and identification information of one or more forward nodes that have forwarded the message along the transmission chain. The chain of each link of the transmission chain may be ordered according to the time when the transaction occurs or each information element of each transmission chain may be attached with a timestamp. The signature can be generated in various ways. For example, the signature may be generated by signing a part of the message (such as an unsigned part of the message) or the whole message. As an example, the source node may generate its signature by signing the whole message and other node may generate its signature by signing an unsigned part of the message such as previous hop node's signature and a next hop node's identification information. In an embodiment, the signature of the source node may be calculated by signing the message and the signature of the forward node or the destination node may be calculated by signing a previous hop node's signature and a next hop node's identification information. For example, the forward node or the destination node may add the next hop node's identification information in the received message, then calculate its signature by signing a previous hop node's signature and the next hop node's identification information, finally add its signature in the received message.

The identification information can be any suitable information which can uniquely identify the node such as node's IP address, node's P2P node identifier, node's Media Access Control (MAC) address, node's public key, node's International Mobile Subscriber Identity (IMSI), etc. and any combination thereof. In an embodiment, the identification information of a node includes a public key and/or address of the node. The address of the node may be IP address or P2P node identifier. It is noted that when there is not any forward node between the source node and the first node, the transmission chain information will not include the signature and identification information of the forward node.

In an embodiment, the transmission chain information may further include a hash of the payload which may be used by the forward node and the destination node to verify the message and/or for other purpose such as generating its signature based on at least of the hash of the payload.

At block 204, the first node updates the transmission chain information by adding identification information of a next hop node in the transmission chain information, generating a signature of the first node, and adding the signature of the first node in the transmission chain information. For example, when the first communication network is the DHT overlay network, the first node may determine the next hop node by using DHT routing algorithm. For example, the first node may calculate its signature by using a previous hop node's signature and the next hop node's identification information.

At block 206, the first node sends the message including the payload and the updated transmission chain information or the updated transmission chain information to the next hop node. In an embodiment, the first node is a forward node, and the first node sends the message including the payload and the updated transmission chain information to the next hop node. In this case, the next node may be a forward node or destination node. In another embodiment, the first node is the destination node, and the first node sends the updated transmission chain information to the next hop node. In the case, the next hop node is a node of a second communication network and the nodes of second communication network will verify the updated transmission chain information and store the verified transmission chain information in a distributed ledger of the second communication network for example when updated transmission chain information has been verified by a predefined number (such as ⅔) of nodes of the second communication network.

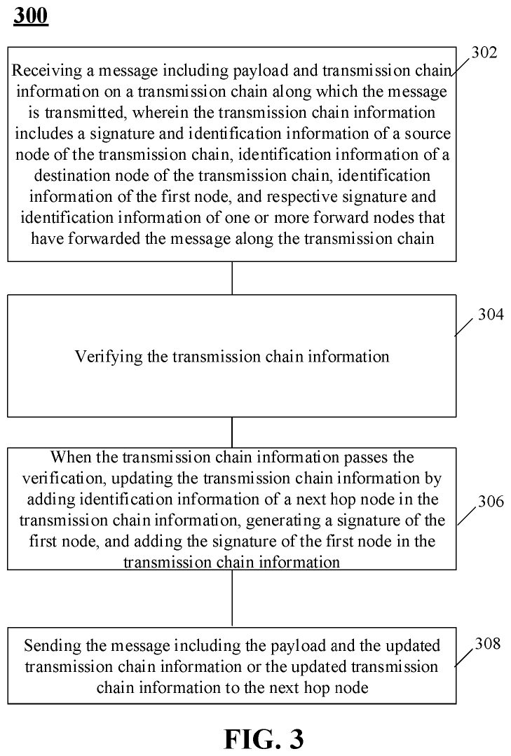

FIG. 3 shows a flowchart of a method according to another embodiment of the present disclosure, which may be performed by an apparatus at a first node of a first communication network or communicatively coupled to a first node of a first communication network. As such, the apparatus may provide means for accomplishing various parts of the method 300 as well as means for accomplishing other processes in conjunction with other components. The first communication network may be the first network 102 or the second network 104 as shown in FIG. 1 or any other suitable communication network. Blocks 302, 306 and 308 are similar to block 202, 204 and 206 of FIG. 2 respectively, and detailed description thereof is omitted here for brevity.

At block 304, the first node may verify the transmission chain information. For example, the first node may verify any information element included in the transmission chain information such as the signature and identification information such as the hash of the payload, signature and identification information. When the transmission chain information has not passed the verification, the first node may omit or delete the message. Otherwise, the method 300 may proceed to block 306. Whether to perform verification function on the forward node may depend on various factors such as the capability of node of the first communication network. In generally, the destination node may be required to perform the verification.

For example, a data packet is valid if and only if the following conditions are satisfied: the hash of the payload is correct, payload size is correct and transmission chain is valid. In addition, the first node may verify whether source node's address and public key match the first element transaction of the transmission chain and/or destination node's address and public key match the last element transaction of the transmission chain. No node can forge or modify a valid transmission chain without controlling (have private keys) of all nodes in the transmission chain. Therefore, a transmission chain cannot be forged because each element transaction may contain the address and public key of the next hop node. If a node on the transmission chain is malicious and removes or modifies some element transactions on the chain when generating its signature, the transmission chain is no longer valid. Similarly, if a partially signed transmission chain is intercepted by a malicious party, no valid transmission chain can be generated without the private key of the designated next node. The last signature on the transmission chain is verifiable to a node of the second communication network, while still being unpredictable and uncontrollable unless all nodes along the transmission chain including source and destination are controlled by the same party. The last signature is essentially deterministic given the payload and the full path, but cannot be computed in advance without all the private keys along the transmission chain.

According to various embodiments, there may be two or more paths between the source node and the destination node for example depending on the specific communication protocol and the destination node may receive two or more messages including different transmission chain information. In this case, the destination node may determine one message from the two or more messages as a final transaction message from the source node to the destination node for example based on a predefined rule. For example, the first message received by the destination node may be used as the final transaction message; the message with the longest transmission chain may be used as the final transaction message; the message with the shortest transmission chain may be used as the final transaction message; and so on.

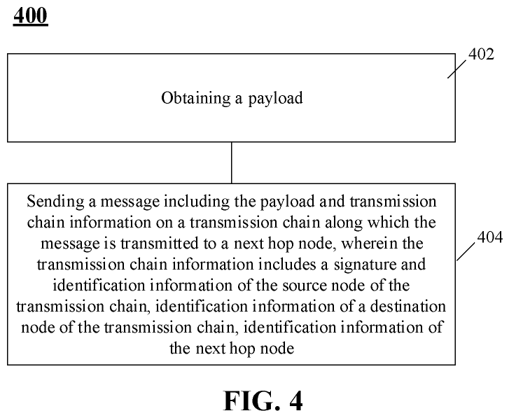

FIG. 4 shows a flowchart of a method according to another embodiment of the present disclosure, which may be performed by an apparatus at a source node of a first communication network or communicatively coupled to a source node of a first communication network. As such, the apparatus may provide means for accomplishing various parts of the method 400 as well as means for accomplishing other processes in conjunction with other components. For some parts which have been described in the above embodiments, detailed description thereof is omitted here for brevity.

At block 402, the source node obtains a payload. The source node may obtain the payload in various ways. For example, the source node may obtain the payload from its storage or from an external storage or from a network device or from its various sensors, etc. The payload can include any suitable data such as music data, video data, file data, transaction data, various IoT data, etc.

At block 404, the source node sends a message including the payload and transmission chain information on a transmission chain along which the message is transmitted to a next hop node. The source node may determine the next hop node based on the specific communication protocol used in the first communication network. The next hop node may be the destination node or a forward node. The transmission chain information may include a signature and identification information of the source node of the transmission chain, identification information of a destination node of the transmission chain, identification information of the next hop node. It is noted that when the destination node and the next hop node is the same node, then the transmission chain information may include a signature and identification information of the source node and identification information of a destination node.

In an embodiment, the signature of the source node may be calculated by signing the message. For example, the source node may add the identification information of the source node, the identification information of the destination node, the identification information of the next hop node in the transmission chain information, then sign the message, and finally add its signature to the transmission chain information.

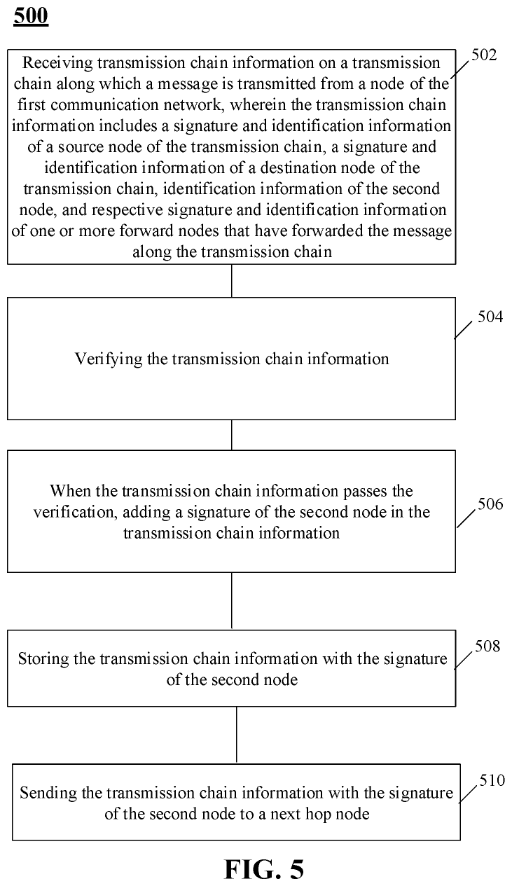

FIG. 5 shows a flowchart of a method according to another embodiment of the present disclosure, which may be performed by an apparatus at second node of a second communication network or communicatively coupled to second node of a second communication network. As such, the apparatus may provide means for accomplishing various parts of the method 500 as well as means for accomplishing other processes in conjunction with other components. The second communication network may be the second network 104 as shown in FIG. 1 or any other suitable communication network. For some parts which have been described in the above embodiments, detailed description thereof is omitted here for brevity.

At block 502, the second node receives transmission chain information on a transmission chain along which a message is transmitted from a node of the first communication network. The first communication network may be the first network 102 or the second network 104 as shown in FIG. 1 or any other suitable communication network. The node of the first communication network may be the destination node or a relay node which may relay the transmission chain information of the message toward the second node. In generally, the transmission chain information of the message may be sent by the destination node.

The transmission chain information may include a signature and identification information of a source node of the transmission chain, a signature and identification information of a destination node of the transmission chain, identification information of the second node, and respective signature and identification information of one or more forward nodes that have forwarded the message along the transmission chain.

At block 504, the second node verifies the transmission chain information. For example, the second node may verify any information element included in the transmission chain information such as the signature and identification information. When the transmission chain information has not passed the verification, the second node may omit or delete the transmission chain information. Otherwise, the method 500 may proceed to block 506.

At block 506, when the transmission chain information passes the verification, the second node adds a signature of the second node in the transmission chain information. For example, the second node may sign a part of the received transmission chain information (such as unsigned part, e.g., the signature of the destination node) or the whole received transmission chain information.

At block 508, the second node stores the transmission chain information with the signature of the second node.

At block 510, the second node sends the transmission chain information with the signature of the second node to a next hop node. The next hop node may include one or more next hop nodes. The second node may determine the one or more next hop nodes in various ways. For example, the second node may randomly select one or more neighbor nodes in its routing table as the one or more next hop nodes. When there are two or more next hop nodes the second node may respectively send the transmission chain information with the signature of the second node to each next hop node. In addition, the second node may add identification information of the next hop node in the transmission chain information.

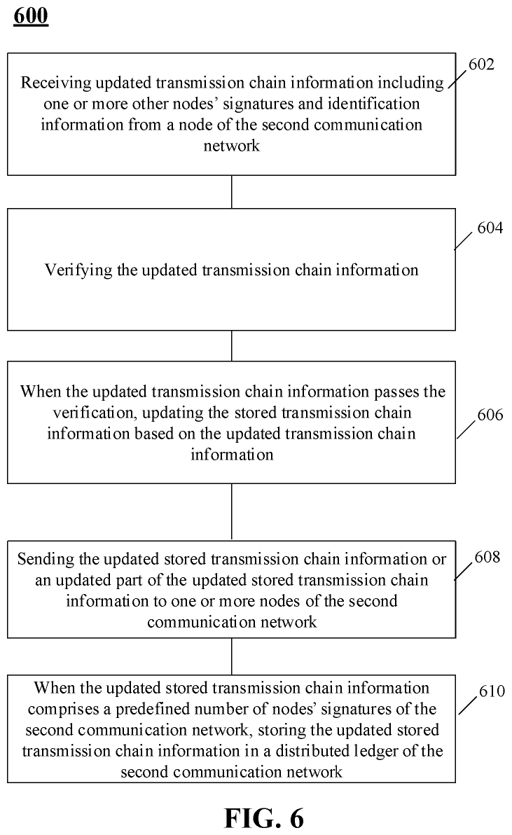

FIG. 6 shows a flowchart of a method according to another embodiment of the present disclosure, which may be performed by an apparatus at second node of a second communication network or communicatively coupled to second node of a second communication network. As such, the apparatus may provide means for accomplishing various parts of the method 600 as well as means for accomplishing other processes in conjunction with other components. The second communication network may be the second network 104 as shown in FIG. 1 or any other suitable communication network. For some parts which have been described in the above embodiments, detailed description thereof is omitted here for brevity.

At block 602, the second node receives updated transmission chain information including one or more other nodes' signatures and identification information from a node of the second communication network. For example, one other node may sign a part of the transmission chain information that the second node has received from the node of the first communication network (such as unsigned part, e.g., the signature of the destination node) or the whole received transmission chain information as well as the identification information of the one other node.

At block 604, the second node verifies the updated transmission chain information. For example, the second node may verify any information element included in the updated transmission chain information such as the signature and identification information. When the updated transmission chain information has not passed the verification, the second node may omit or delete the updated transmission chain information. Otherwise, the method 600 may proceed to block 606.

At block 606, when the updated transmission chain information passes the verification, the second node updates the stored transmission chain information based on the updated transmission chain information. For example, the second node may compare the stored transmission chain information with the updated transmission chain information to find the updated information and then update the updated information to its stored transmission chain information.

At block 608, the second node sends the updated stored transmission chain information or an updated part of the updated stored transmission chain information to one or more nodes of the second communication network. The second node may determine the one or more nodes in various ways. For example, the second node may randomly select one or more nodes neighbor nodes in its routing table as the one or more nodes. The neighbor nodes such as CGNs that receive the updated stored transmission chain information will perform the similar action of the second node until all nodes in the second communication network receive the updated stored transmission chain information. The process of updating transmission chain information may take some time. Since there is no guarantee that all nodes in the second communication network will receive the updated stored transmission chain information at a certain moment, but in theory all nodes will eventually receive the updated stored transmission chain information, which is a final agreement.

As with IoT platforms facing complex open environments, it needs to ensure the security of proof of transmission in the case of malicious attacks. The transmission chain is unpredictable and uncontrollable as long as the private key of at least one node is kept secret. However, if a malicious party controls all nodes on the route including source and destination, the party is able to predict and create valid transmission chain without actually transmitting the payload. To solve this problem, randomizing the relayer selection or using relayer being assigned by a node of the second communication network is a measure to alleviate collusion attacks.

Generally, the broadcast protocol in the traditional blockchain technology stipulates that a node randomly selects surrounding nodes to periodically send messages, and the node that receives the message repeats this operation, so that it is inevitable that the message is repeatedly sent to the same node. The redundancy of the message also increases the processing pressure of the node receiving the message. This embodiment can solve the problem of transmission chain information redundancy by propagating only newly arrived data, i.e., the updated part of the updated stored transmission chain information. Therefore, the transmission chain information can be sent more frequently because the transmission chain information contains only the latest update and is smaller.

The propagation mechanism of the transmission chain information has the following benefits. Highly scalable: the network can allow any increase and decrease of nodes in the second communication network, and the state of newly added nodes in the second communication network will eventually be consistent with other nodes in the second communication network. Fault tolerance: the downtime and restart of any nodes in the second communication network will not affect the propagation of the transmission chain information. The propagation mechanism has a natural distributed system fault tolerance. Semi-distributed structure improves efficiency. The propagation mechanism requires that the transmission chain information in the first communication network be propagated through the node in second communication network. The nodes in the second communication network can be peer-to-peer. Any node in the second communication network does not need to know the entire network condition, as long as the network is connected. The nodes in the second communication network can then spread the transmission chain information to the second communication network. Consistency convergence: the transmission chain information will spread rapidly in the second communication network at an exponential speed, so the inconsistency of the system state can converge to the same in a very short time. The transmission chain information propagation speed can reach log N. Simple: The process of the propagation mechanism is simple and easy to implement.

In the traditional broadcast protocol, the node only randomly sends messages to a few nodes, and the message finally reaches the whole network through multiple rounds of spreading, so using the broadcast protocol in the whole network will cause unavoidable message delay. This is likely to make it unsuitable for use in scenarios with high real-time requirements like the IoT platform. By using the proposed propagation mechanism, the first communication network and the second communication network can effectively improve the transmission chain information delay. Because the transmission chain information is generated in the first communication network such as Fog network, but the first communication network does not participate in the distributed (such as DAG) ledger accounting process, the destination node of the first communication network is transparently transmitting the transmission chain information to a node (such as physically or temporally nearest node) of the second communication node. As a proxy of the first communication network, the nodes of the second communication node perform fast propagation in a small range of the second communication nodes to reduce the consensus response speed caused by the delay of the transmission chain information.

In an embodiment, the transmission chain information further includes a time out mechanism for transmission, and the transmission chain information will be propagated based on the time out mechanism for transmission. For example, the transmission chain information will be marked as “failed” after a certain point in time or a predefined number of hops and will no longer be propagated. Therefore, in the propagation mechanism, there is a certain probability of inconsistency. But as long as the scope is controlled within ⅓ of the number of nodes in the second communication network, the final consistency can be achieved through a consensus mechanism (such as asynchronous Byzantine fault tolerance). Since according to the time out mechanism, it does not propagate the transmission chain information for example after a certain time point, the transmission chain information is limited, so the system overhead is small.

The DAG consensus of second communication network uses the propagation mechanism. This means that a node such as CGN of the second communication network such as Alice can randomly select at least one CGN in its maintained routing table, such as Bob and Carl, and then Alice tells Bob and Carl all the transmission chain information she has collected and built so far. Alice can repeatedly randomly select other members of its routing table. Bob and Carl repeat this process, and all other CGNs do the same. In this way, when a CGN updates a transmission chain, it will quickly spread to the entire community at a geometric exponential. Each CGN gets the latest state of the transmission chain. The synchronization of the latest transmission chain information between two CGNs is called transmission chain synchronization. After the transmission chain synchronization ends, each participating CGN will synchronously record the transmission chain as a structured data stored in its storage.

At block 610, when the updated stored transmission chain information comprises a predefined number of nodes' signatures of the second communication network, the second node stores the updated stored transmission chain information in a distributed ledger of the second communication network. The predefined number can be ⅔, ¾, ⅘ or all of nodes in the second communication network or all the nodes.

It is not sufficient for each CGN to know that each transmission chain is updated. It is also necessary to agree on the chain ordering of each link of the transmission chain according to the time when the transaction occurs. All transaction information related to the transmission chain is recorded in each transmission chain. In the prior art, most of the Byzantine fault tolerant agreements without leaders send votes to each other by consensus nodes, and some agreements require that the receipt of voting be sent to each consensus node, which will further increase the number of the sent voting messages. This purely voting approach has a high requirement for the network to make a large number of voting networks unrealizable. This embodiment can achieve the acquisition of voting information by collecting and constructing the transmission chain, and achieves the same fairness and security but is very fast and practical. In this embodiment, it can extract corresponding transaction information from the process of constructing each transmission chain in the CGN, so that a subsequent re-voting process is not required. The consensus algorithm does not send any votes to accumulate votes for each CGN. Each CGN can calculate its GGN voting by looking at a local backup of the transmission chain for a specific time. Therefore, the consensus mechanism has several following advantages. In addition to saving bandwidth, it also ensures that GGN always counts votes through uniform rules. Even if there is a malicious node in the CGN, the node cannot attack the current specific honest CGN by manipulating the transmission chain information. Through this consensus mechanism, Byzantine fault tolerance is guaranteed. In an embodiment, the consensus of the invention can be divided into two steps: 1) building and extending the transmission chain and 2) judging the completed transmission chain in a witness process of the second communication network. For example, firstly, it may build and extend the transmission chain. To begin calculating the voting structure, it may first be determined that the transmission chain has completed in the first communication network and that the transmission chain has completed expansion in the CG (cloud graph). The first transmission chain element transaction reception record of a CGN node is the first witness of the CGN node to the transmission chain. The first testimony is the beginning of the first round (r) of this CGN node. All subsequent updates to the transmission chain are part of the first round to know that a new witness has been discovered. A new testimony was discovered when a node created a transmission chain that confirmed the current round of witnesses and was the witness for the next round. For example, the transmission chain w can be traced back to the transaction x by constructing the historical relationship of the transmission chain through the signatures of at least a predefined number (such as ⅔) of CGN nodes, and it can be considered that the transaction x is confirmed. This newly issued testimony is the first transmission chain element transaction for the next round (r+1) of this CGN node. Each transmission chain element transaction is assigned a round value when it is added to the DAG map store. The next step is to determine if a testimony is valid. If a witness can be seen by most of the next round of transmission chains, then it is deterministic. If the transmission chain element transaction A is the previous associated transaction of the transmission chain element transaction B, then B can confirm A. When it is determined whether the transmission chain element transaction B is confirmed, it is necessary to check those witnesses in the next round. If the next round of witnesses can confirm witness B, they are counted as supporting witness B being confirmed. Similarly, if the next round of witnesses cannot confirm witness B, it is recorded as witness B is not confirmed a vote. If witness B is to be considered confirmed, then it needs to have a predefined number such as ⅔ of witness support ticket in the next round. If the predefined number such as ⅔ of votes considers that B is not confirmed, then B is judged to be invalid, and the transmission chain is also invalid. A transmission chain is considered invalid if only one element transaction is determined to be invalid.

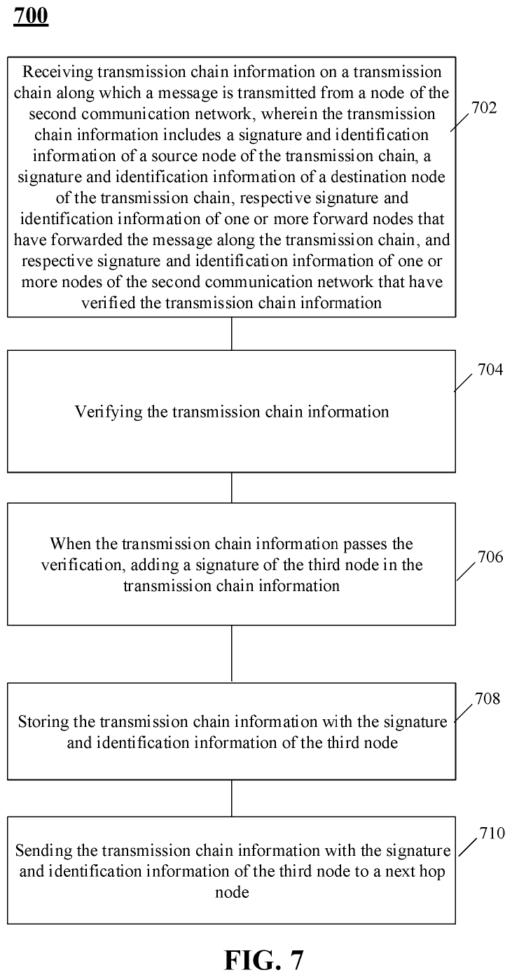

FIG. 7 shows a flowchart of a method according to another embodiment of the present disclosure, which may be performed by an apparatus at third node of a second communication network or communicatively coupled to third node of a second communication network. As such, the apparatus may provide means for accomplishing various parts of the method 700 as well as means for accomplishing other processes in conjunction with other components. The second communication network may be the second network 104 as shown in FIG. 1 or any other suitable communication network. For some parts which have been described in the above embodiments, detailed description thereof is omitted here for brevity.

At block 702, the third node receives transmission chain information on a transmission chain along which a message is transmitted from a node of the second communication network. The transmission chain information may include a signature and identification information of a source node of the transmission chain, a signature and identification information of a destination node of the transmission chain, respective signature and identification information of one or more forward nodes that have forwarded the message along the transmission chain, and respective signature and identification information of one or more nodes of the second communication network that have verified the transmission chain information. In addition, the transmission chain information may further include identification information of the third node.

At block 704, the third node verifies the transmission chain information. For example, the third node may verify any information element included in the transmission chain information such as the signature and identification information. When the transmission chain information has not passed the verification, the third node may omit or delete the transmission chain information. Otherwise, the method 700 may proceed to block 706.

At block 706, when the transmission chain information passes the verification, the third node may add a signature of the third node in the transmission chain information. For example, the third node may sign a part of the transmission chain information that the second node has received from the node of the first communication network (such as unsigned part, e.g., the signature of the destination node) or the whole received transmission chain information as well as the identification information of the third node. In addition, the third node may add the identification information of the next hop node of the second communication network in the transmission chain information.

At block 708, the third node stores the transmission chain information with the signature and identification information of the third node.

At block 710, the second node sends the transmission chain information with the signature and identification information of the third node to a next hop node. The next hop node may include one or more next hop nodes. The third node may determine the one or more next hop nodes in various ways. For example, the third node may randomly select one or more neighbor nodes in its routing table as the one or more next hop nodes. When there are two or more next hop nodes, the third node may respectively send the transmission chain information with the signature and identification information of the third node to each next hop node. In addition, the third node may add identification information of the next hop node in the transmission chain information before sending to the next hop.

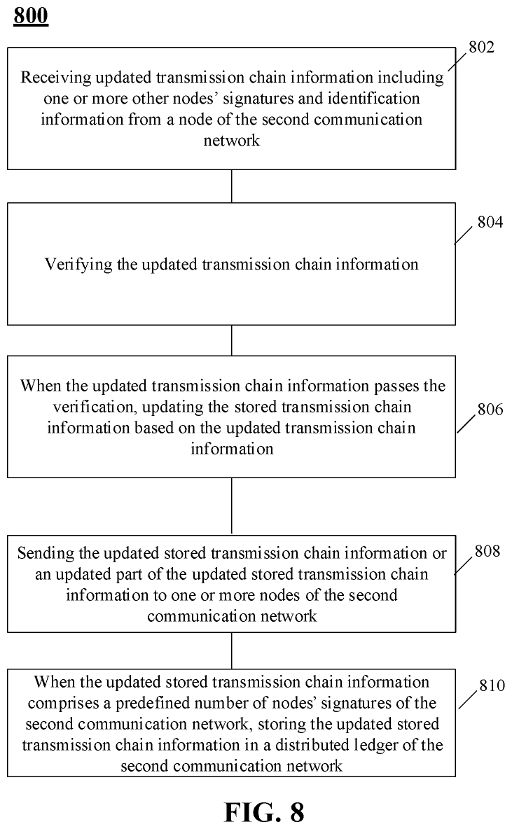

FIG. 8 shows a flowchart of a method according to another embodiment of the present disclosure, which may be performed by an apparatus at a third node of a second communication network or communicatively coupled to a third node of a second communication network. As such, the apparatus may provide means for accomplishing various parts of the method 800 as well as means for accomplishing other processes in conjunction with other components. The second communication network may be the second network 104 as shown in FIG. 1 or any other suitable communication network. For some parts which have been described in the above embodiments, detailed description thereof is omitted here for brevity.

At block 802, the third node receives updated transmission chain information including one or more other nodes' signatures and identification information from a node of the second communication network. The generation of one or more other nodes' signatures may be similar to the generation of the third node's signature.

At block 804, the third node verifies the updated transmission chain information. For example, the third node may verify any information element included in the updated transmission chain information such as the signature and identification information. When the updated transmission chain information has not passed the verification, the third node may omit or delete the updated transmission chain information. Otherwise, the method 800 may proceed to block 806.

At block 806, when the updated transmission chain information passes the verification, the third node updates the stored transmission chain information based on the updated transmission chain information. For example, the third node may compare the stored transmission chain information with the updated transmission chain information to find the updated information and then update the updated information to its stored transmission chain information.

At block 808, the third node sends the updated stored transmission chain information or an updated part of the updated stored transmission chain information to one or more nodes of the second communication network. The second node may determine the one or more nodes in various ways. For example, the third node may randomly select one or more nodes neighbor nodes in its routing table as the one or more nodes. The neighbor nodes such as CGNs that receive the updated stored transmission chain information will perform the similar action of the third node until all nodes in the second communication network receive the updated stored transmission chain information.

At block 810, when the updated stored transmission chain information comprises a predefined number of nodes' signatures of the second communication network, the third node stores the updated stored transmission chain information in a distributed ledger of the second communication network. The predefined number can be ⅔, ¾, ⅘ or all of nodes in the second communication network or all the nodes.

According to various embodiments, the first communication network may be an overlay network such as DHT overlay network.

According to various embodiments, a peer discovery, routing algorithm and tunnel establishment of the overlay network of the first communication network may use a DHT routing algorithm.

According to various embodiments, the second communication network may be an overlay network.

According to various embodiments, a peer discovery, routing algorithm and tunnel establishment of the overlay network of the second communication network may use a DHT routing algorithm.

According to various embodiments, the first communication network may comprise IoT devices and the second communication network may comprise servers.

According to various embodiments, the IoT devices may comprise IoT routers such as FNR and IoT terminals such as FNT.

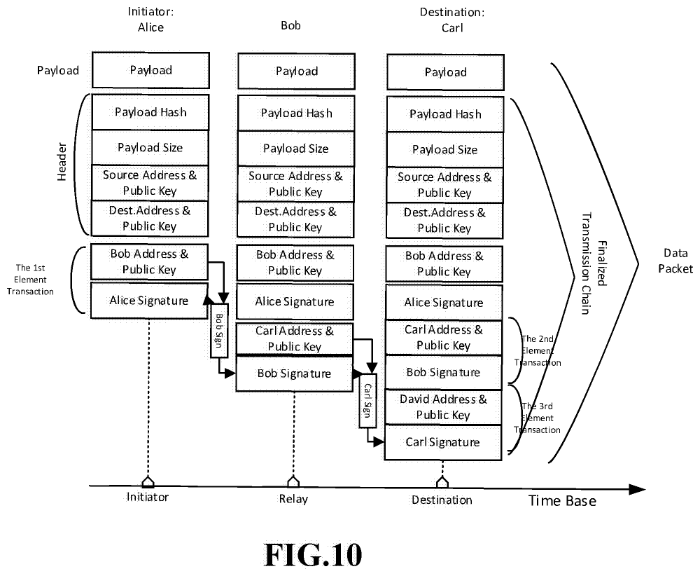

FIG. 10 schematically shows a construction process of a transmission chain. As illustrated in FIG. 10, in the first communication network such as fog network, the source node (i.e., initiator Alice) may sign the payload, the header and the Bob address & public key, the relay node (i.e., Bob) may sign the Bob address & public key and Alice signature, and the destination node (i.e., Carl) may sign the Carl address & public key and Bob signature.

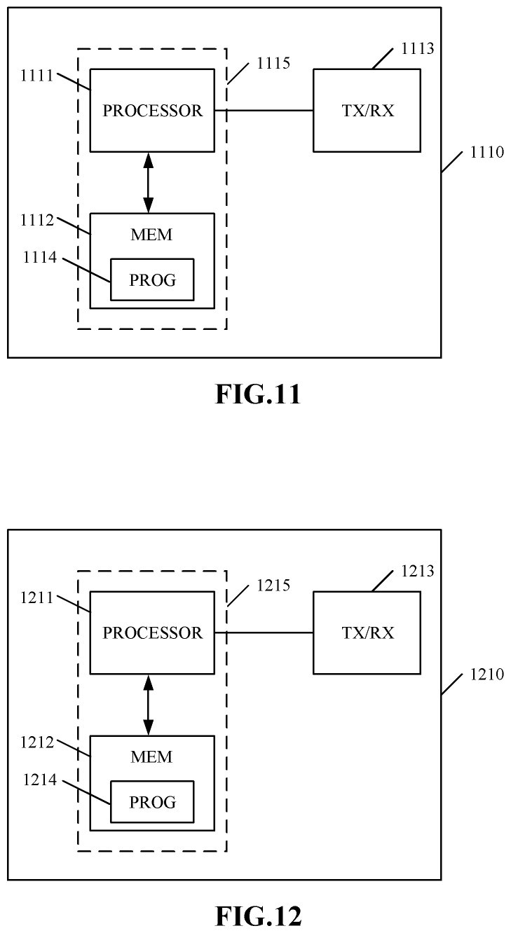

FIG. 11 illustrates a simplified block diagram of an apparatus 1110 that may be embodied in/as a first node of a first communication network to an embodiment of the present disclosure.

The apparatus 1110 may comprise at least one processor 1111, such as a data processor (DP) and at least one memory (MEM) 1112 coupled to the processor 1111. The apparatus 1110 may further comprise a transmitter TX and receiver RX 1113 coupled to the processor 1111. The MEM 1112 stores a program (PROG) 1114. The PROG 1114 may include instructions that, when executed on the associated processor 1111, enable the apparatus 1110 to operate in accordance with the embodiments of the present disclosure, for example to perform any of the methods related to the first node of a first communication network. A combination of the at least one processor 1111 and the at least one MEM 1112 may form processing means 1115 adapted to implement various embodiments of the present disclosure.

FIG. 12 illustrates a simplified block diagram of an apparatus 1210 that may be embodied in/as a source node of a first communication network to an embodiment of the present disclosure.

The apparatus 1210 may comprise at least one processor 1211, such as a data processor (DP) and at least one memory (MEM) 1212 coupled to the processor 1211. The apparatus 1210 may further comprise a transmitter TX and receiver RX 1213 coupled to the processor 1211. The MEM 1212 stores a program (PROG) 1214. The PROG 1214 may include instructions that, when executed on the associated processor 1211, enable the apparatus 1210 to operate in accordance with the embodiments of the present disclosure, for example to perform any of the methods related to the source node of a first communication network. A combination of the at least one processor 1211 and the at least one MEM 1212 may form processing means 1215 adapted to implement various embodiments of the present disclosure.

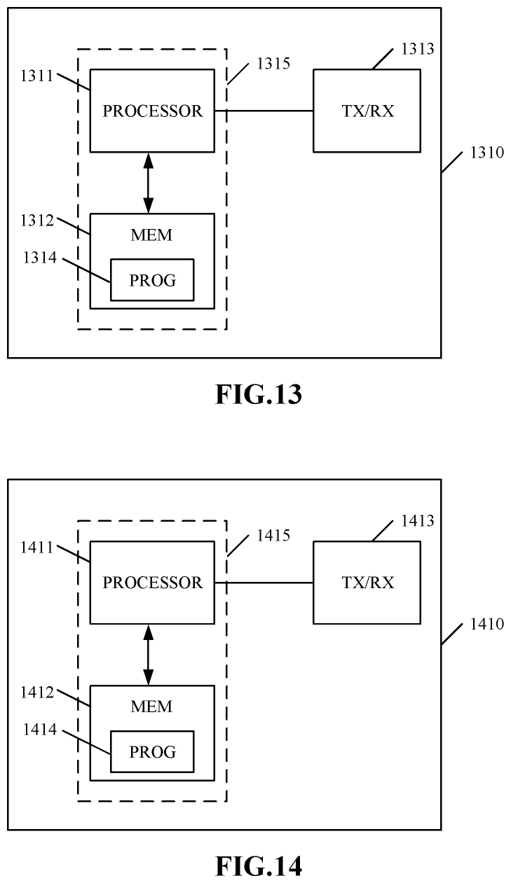

FIG. 13 illustrates a simplified block diagram of an apparatus 1310 that may be embodied in/as a second node of a second communication network to an embodiment of the present disclosure.

The apparatus 1310 may comprise at least one processor 1311, such as a data processor (DP) and at least one memory (MEM) 1312 coupled to the processor 1311. The apparatus 1310 may further comprise a transmitter TX and receiver RX 1313 coupled to the processor 1311. The MEM 1312 stores a program (PROG) 1314. The PROG 1314 may include instructions that, when executed on the associated processor 1311, enable the apparatus 1310 to operate in accordance with the embodiments of the present disclosure, for example to perform any of the methods related to the second node of the second communication network. A combination of the at least one processor 1311 and the at least one MEM 1312 may form processing means 1315 adapted to implement various embodiments of the present disclosure.

FIG. 14 illustrates a simplified block diagram of an apparatus 1410 that may be embodied in/as a third node of a second communication network to an embodiment of the present disclosure.

The apparatus 1410 may comprise at least one processor 1411, such as a data processor (DP) and at least one memory (MEM) 1412 coupled to the processor 1411. The apparatus 1410 may further comprise a transmitter TX and receiver RX 1413 coupled to the processor 1411. The MEM 1412 stores a program (PROG) 1414. The PROG 1414 may include instructions that, when executed on the associated processor 1411, enable the apparatus 1410 to operate in accordance with the embodiments of the present disclosure, for example to perform any of the methods related to the third node of the second communication network. A combination of the at least one processor 1411 and the at least one MEM 1412 may form processing means 1415 adapted to implement various embodiments of the present disclosure.

Various embodiments of the present disclosure may be implemented by computer program executable by one or more of the processors 1111, 1211, 1311 and 1411, software, firmware, hardware or in a combination thereof.

The MEMs 1112, 1212, 1312 and 1412 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processors 1111, 1211, 1311 and 1411 may be of any type suitable to the local technical environment, and may include one or more of general purpose computers, special purpose computers, microprocessors, digital signal processors DSPs and processors based on multicore processor architecture, as non-limiting examples.

According to an aspect of the disclosure it is provided a computer program product being tangibly stored on a computer readable storage medium and including instructions which, when executed on at least one processor, cause the at least one processor to carry out any of the methods related to the first node of the first communication network as described above.

According to an aspect of the disclosure it is provided a computer-readable storage medium storing instructions which when executed by at least one processor, cause the at least one processor to carry out any of the methods related to related to the first node of the first communication network as described above as described above.

According to an aspect of the disclosure it is provided a computer program product being tangibly stored on a computer readable storage medium and including instructions which, when executed on at least one processor, cause the at least one processor to carry out any of the methods related to the source node of the first communication network as described above.

According to an aspect of the disclosure it is provided a computer-readable storage medium storing instructions which when executed by at least one processor, cause the at least one processor to carry out any of the methods related to the source node of the first communication network as described above.

According to an aspect of the disclosure it is provided a computer program product being tangibly stored on a computer readable storage medium and including instructions which, when executed on at least one processor, cause the at least one processor to carry out any of the methods related to the second node of the second communication network as described above.

According to an aspect of the disclosure it is provided a computer-readable storage medium storing instructions which when executed by at least one processor, cause the at least one processor to carry out any of the methods related to the second node of the second communication network as described above.

According to an aspect of the disclosure it is provided a computer program product being tangibly stored on a computer readable storage medium and including instructions which, when executed on at least one processor, cause the at least one processor to carry out any of the methods related to the third node of a second communication network as described above.

According to an aspect of the disclosure it is provided a computer-readable storage medium storing instructions which when executed by at least one processor, cause the at least one processor to carry out any of the methods related to the third node of a second communication network as described above.

According to an aspect of the disclosure, there is provided a system. The system comprises a first communication network including a plurality of apparatus at the nodes of the first communication network as described above and a second communication network including a plurality of apparatus at the nodes of the second communication network as described above.

The distributed ledger according to various embodiments of the disclosure has the following benefits. There is significant autonomy compared to the central server by using the proposed distributed ledger technology. It can leverage resources at the edge of the network, such as storage/computing capabilities and information resources. It no longer needs a specific central management mechanism, and all nodes in the system have a peer relationship. This aspect brings the advantages of self-organization, fault tolerance and scalability to the system.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-57. (canceled)

58. A method at a first node of a first communication network, comprising:
receiving a message including payload and transmission chain information on a transmission chain along which the message is transmitted, wherein the transmission chain information includes a signature and identification information of a source node of the transmission chain, identification information of a destination node of the transmission chain, identification information of the first node, and respective signature and identification information of one or more forward nodes that have forwarded the message along the transmission chain;
updating the transmission chain information by adding identification information of a next hop node in the transmission chain information, generating a signature of the first node, and adding the signature of the first node in the transmission chain information; and
sending the message including the payload and the updated transmission chain information or the updated transmission chain information to the next hop node.

59. The method according to claim 58, further comprising
verifying (304) the transmission chain information.

60. The method according to claim 58, wherein the transmission chain information further includes a hash of the payload.

61. The method according to claim 58, wherein the identification information of a node includes a public key and/or address of the node; and wherein the signature of the source node is calculated by signing the message and the signature of the forward node or the destination node is calculated by signing a previous hop node's signature and a next hop node's identification information.

62. The method according to claim 58, wherein the first communication network is an overlay network; and wherein a peer discovery, routing algorithm and tunnel establishment of the overlay network of the first communication network use a distributed hash table (DHT) routing algorithm.

63. The method according to claim 58, wherein the first node is a forward node, and sending the message including the payload and the updated transmission chain information or the updated transmission chain information to a next hop node comprises:
sending the message including the payload and the updated transmission chain information to the next hop node.

64. The method according to claim 58, wherein the first node is the destination node, and sending the message including the payload and the updated transmission chain information or the updated transmission chain information to a next hop node comprises:
sending the updated transmission chain information to the next hop node,
wherein the next hop node is a node of a second communication network and the nodes of second communication network verify the updated transmission chain information and store the verified transmission chain information in a distributed ledger of the second communication network.

65. The method according to claim 58, wherein the second communication network is an overlay network; and
wherein a peer discovery, routing algorithm and tunnel establishment of the overlay network of the second communication network use a distributed hash table (DHT) routing algorithm.

66. The method according to claim 58, wherein the first communication network comprises Internet of things (IoT) devices and the second communication network comprises servers; and wherein the IoT devices comprise IoT routers and IoT terminals.

67. A method at a second node of a second communication network, comprising:
receiving transmission chain information on a transmission chain along which a message is transmitted from a node of the first communication network, wherein the transmission chain information includes a signature and identification information of a source node of the transmission chain, a signature and identification information of a destination node of the transmission chain, identification information of the second node, and respective signature and identification information of one or more forward nodes that have forwarded the message along the transmission chain;
verifying the transmission chain information;
when the transmission chain information passes the verification, adding a signature of the second node in the transmission chain information;
storing the transmission chain information with the signature of the second node; and
sending the transmission chain information with the signature of the second node to a next hop node.

68. The method according to claim 67, wherein the transmission chain information further includes a hash of payload.

69. The method according to claim 67, wherein the identification information of a node includes a public key and/or address of the node; and
wherein the signature of the source node is calculated by signing the message and the signature of the forward node or the destination node is calculated by signing a previous hop node's signature and a next hop node's identification information.

70. The method according to claim 67, wherein the first communication network is an overlay network; wherein a peer discovery, routing algorithm and tunnel establishment of the overlay network of the first communication network use a distributed hash table (DHT) routing algorithm.

71. The method according to claim 67, wherein the second communication network is an overlay network; and wherein a peer discovery, routing algorithm and tunnel establishment of the overlay network of the second communication network use a distributed hash table (DHT) routing algorithm.

72. The method according to claim 67, wherein the first communication network comprises Internet of things (IoT) devices and the second communication network comprises servers; wherein the Internet of thing devices comprise IoT routers and IoT terminals.

73. The method according to claim 67, further comprising
receiving updated transmission chain information including one or more other nodes' signatures and identification information from a node of the second communication network;
verifying the updated transmission chain information;
when the updated transmission chain information passes the verification, updating the stored transmission chain information based on the updated transmission chain information;
sending the updated stored transmission chain information or an updated part of the updated stored transmission chain information to one or more nodes of the second communication network; and
when the updated stored transmission chain information comprises a predefined number of nodes' signatures of the second communication network, storing the updated stored transmission chain information in a distributed ledger of the second communication network.

74. The method according to claim 67, wherein the transmission chain information further includes a time out mechanism for transmission, and the transmission chain information will be propagated based on the time out mechanism for transmission.

75. An apparatus at a first node of a first communication network, comprising:
a processor; and
a memory coupled to the processor, said memory containing instructions executable by said processor, whereby said apparatus is operative to:
receive a message including payload and transmission chain information on a transmission chain along which the message is transmitted, wherein the transmission chain information includes a signature and identification information of a source node of the transmission chain, identification information of a destination node of the transmission chain, identification information of the first node, and respective signature and identification information of one or more forward nodes that have forwarded the message along the transmission chain;
update the transmission chain information by adding identification information of a next hop node in the transmission chain information, generating a signature of the first node, and adding the signature of the first node in the transmission chain information; and
send the message including the payload and the updated transmission chain information or the updated transmission chain information to the next hop node.

76. An apparatus at a second node of a second communication network, comprising:
a processor; and
a memory coupled to the processor, said memory containing instructions executable by said processor, whereby said apparatus is operative to:
receive transmission chain information on a transmission chain along which a message is transmitted from anode of the first communication network, wherein the transmission chain information includes a signature and identification information of a source node of the transmission chain, a signature and identification information of a destination node of the transmission chain, identification information of the second node, and respective signature and identification information of one or more forward nodes that have forwarded the message along the transmission chain;
verify the transmission chain information;
when the transmission chain information passes the verification, add a signature of the second node in the transmission chain information;
store the transmission chain information with the signature of the second node; and
send the transmission chain information with the signature of the second node to a next hop node.
